(19) United States
(12) Patent Application Publication
(10) Pub. No.: US 2022/0276428 A1
(43) Pub. Date: Sep. 1, 2022

(54) TRANSPARENT LIGHT GUIDE PLATE AND LIGHTING DEVICE INCLUDING SAME

(71) Applicant: CORNING INCORPORATED, CORNING, NY (US)

(72) Inventor: JooYoung Lee, Asan-si (KR)

(21) Appl. No.: 17/618,126

(22) PCT Filed: Jun. 10, 2020
(86) PCT No.: PCT/US2020/036952

§ 371 Date: Dec. 10, 2021

(30) Foreign Application Priority Data
Jun. 19, 2019 (KR) 10-2019-0072982

(51) Int. Cl. F21V 8/00

(52) U.S. Cl. CPC G02B 6/0051; G02B 6/0043; G02B 6/0086; G02B 6/0073

(57) ABSTRACT

Provided are a transparent light guide plate able to emit light through opposing surfaces and allowing for adjustment of the ratio between intensities of light exiting through the opposing surfaces, and a lighting device including the same. In the transparent light guide plate, a transparent base has a first surface with a light-scattering layer disposed thereon. The light-scattering layer includes a matrix layered on the first surface and a number of light-scattering particles dispersed in the matrix. A dot pattern is disposed on the light-scattering layer with some formed from a light-absorbing material and some formed from a light-reflective material.

### CROSS-REFERENCE TO RELATED APPLICATIONS

This application claims the benefit of priority under 35 U.S.C § 119 of Korean Patent Application No. 10-2019-0072982 filed on Jun. 19, 2019, the content of which is relied upon and incorporated herein by reference in its entirety.

### FIELD

The present disclosure relates to a transparent light guide plate and a lighting device including the same and, more particularly, to a transparent light guide plate able to emit light through opposing surfaces and allowing for adjustment of the ratio between intensities of light exiting through the opposing surfaces, and a lighting device including the same.

### DESCRIPTION OF RELATED ART

In general, a light guide plate uses a phenomenon in which light from a light-emitting diode (LED) disposed to face at least one of four surfaces of a transparent plate is totally reflected within the transparent plate. A variety of methods have been used to emit an intended intensity of light from an intended location of the transparent plate. Such optimization or maximization of the intensity of exiting light has been an issue to be solved for a long period.

In general, a large amount of effort has been exerted to extract light through one surface of a transparent plate. On the other hand, it may be significantly useful to extract light through both surfaces of a transparent plate for a plurality of purposes or uses. However, in this regard, an insignificant amount of research has been performed.

### SUMMARY

Various aspects of the present disclosure provide a transparent light guide plate able to emit light through opposing surfaces and allowing for adjustment of the ratio between intensities of light exiting through the opposing surfaces, and a lighting device including the same.

In this regard, the present disclosure provides in one aspect, a transparent light guide plate including: a transparent base having a first surface, a second surface opposing the first surface, and third surfaces connecting the first surface and the second surface to each other; a light-scattering layer disposed on the first surface, and including a matrix layered on the first surface and a number of light-scattering particles dispersed in the matrix; and a dot pattern disposed on the light-scattering layer, and including at least one of a number of first dots formed from a light-absorbing material and a number of second dots formed from a light-reflective material.

In some embodiments, the matrix may have a surface roughness Ra of 1 μm or less.

In some embodiments, a central portion of the light-scattering layer may be thicker than a peripheral portion of the light-scattering layer.

In some embodiments, the matrix may contain one of polydimethylsiloxane (PDMS), silsesquioxane (SSQ), and siloxane.

In some embodiments the number of light-scattering particles may be distributed more densely in a central portion of the light-scattering layer than in a peripheral portion of the light-scattering layer

In some embodiments, the light-scattering particles may contain at least one selected from the candidate group consisting of SiO₂, TiO₂, BaTiO₃, ZnO, ZrO₂, and SnO₂.

In some embodiments, the first dots may be formed from a material having a reflectance of 10% or less.

In some embodiments, the second dots may be formed from a material having a reflectance of 50% or more.

In some embodiments, the thickness of each of the light-scattering layer and the dot pattern may range from 110 nm to 20 μm.

The present disclosure also provides, in one aspect, a lighting device including: the above-described transparent light guide plate; at least one light-emitting diode facing at least one surface of the third surfaces defining side surfaces of the transparent light guide plate; a frame providing an accommodation space for the transparent light guide plate and the light-emitting diode such that the first surface and a second surface are exposed.

In some embodiments, the lighting device may emit light through both the first surface and the second surface of the transparent light guide plate when the light-emitting diode is on.

In some embodiments, the transparent light guide plate may remain transparent when the light-emitting diode is off.

In some embodiments, the haze of the transparent light guide plate may be 30% or less.

In some embodiments, the transmittance of the transparent light guide plate may be 80% or higher.

According to exemplary embodiments, the transparent light guide plate is provided by forming the light-scattering layer having the plurality of light-scattering particles dispersed therein on the transparent base, and forming the dot pattern including the plurality of dots formed from a light-absorbing material and the plurality of dots formed from a reflecting material on a portion of the surface of the light-scattering layer. When the transparent light guide plate is used in the edge-lit lighting device using LEDs as a light source, the transparent light guide plate can serve as a light guide plate enabling dual-surface lighting while allowing the ratio of intensities of light exiting through both surfaces to be easily adjusted.

In addition, the plurality of dots of the dot pattern are formed with an invisible size, such that the transparent light guide plate remains transparent when the LEDs are in a turned-off state. Accordingly, the lighting device including the transparent light guide plate can provide a variety of uses.

### DESCRIPTION OF THE DRAWINGS

FIG. 1 is a cross-sectional view schematically illustrating a transparent light guide plate according to an exemplary embodiment;

FIGS. 2 and 3 are cross-sectional views schematically illustrating a variety of structures of the light-scattering layer of a transparent light guide plate according to an exemplary embodiment;

FIGS. 4 to 7 are plan views schematically illustrating a variety of arrangements of a dot pattern of a transparent light guide plate according to an exemplary embodiment;

FIGS. 8A and 8B are electron microscope images taken from a cross-section of a transparent light guide plate according to an exemplary embodiment;

FIG. 9 is a schematic view illustrating a lighting device including a transparent light guide plate according to an exemplary embodiment;

FIG. 10 shows images of on and off states of the lighting device including a transparent light guide plate according to an exemplary embodiment; and

FIGS. 11 to 14 are cross-sectional views schematically illustrating transparent light guide plates according to a comparative example.

### DETAILED DESCRIPTION

Hereinafter, a transparent light guide plate and a lighting device including the same according to exemplary embodiments will be described in detail with reference to the accompanying drawings.

In the following description, detailed descriptions of known functions and components incorporated in the present disclosure will be omitted in the case in which the subject matter of the present disclosure is rendered unclear by the inclusion thereof.

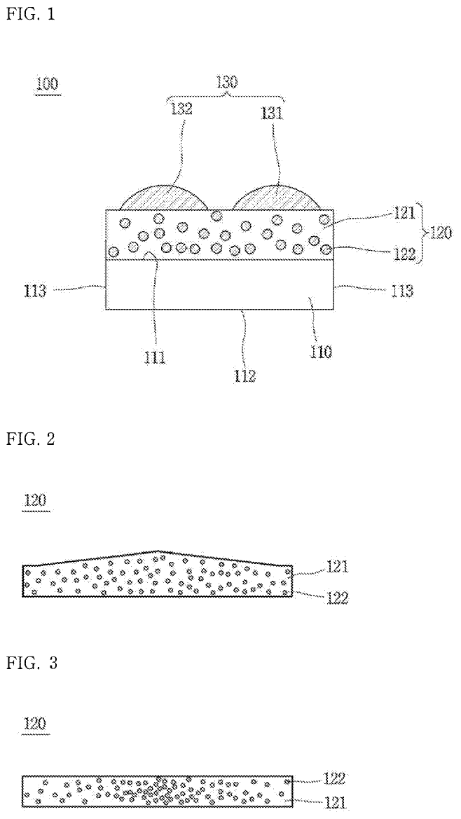

As illustrated in FIG. 1, a transparent light guide plate 100 according to an exemplary embodiment includes a transparent base 110, a light-scattering layer 120, and a dot pattern 130.

The transparent base 110 includes a first surface 111, a second surface 112 opposing the first surface 111, and a third surface 113 connecting the first surface 111 and the second surface 112.

According to an embodiment, the first surface may define a top surface (in the drawing) of the transparent base 110, through which light emitted by light-emitting diodes (LEDs) 20 (in FIG. 9) exits. In addition, the second surface 112 may define a bottom surface (in the drawing) of the transparent base 110, through which light emitted by the LEDs 20 (in FIG. 9) exits, like the first surface 111. Accordingly, a lighting device 10 (in FIG. 9) including the transparent light guide plate 100 according to the exemplary embodiment emits light through the first surface 111 and the second surface 112. In addition, the third surface 113 may define one side surface or both side surfaces of the transparent base 110 facing the LEDs 20 (in FIG. 9), since the lighting device 10 (in FIG. 9) is an edge-lit lighting device.

According to an embodiment, the transparent base 110 may be formed from a glass material in the shape of a plate. For example, the transparent base 110 may be formed from non-alkali glass, silica glass, low-iron glass, soda-lime glass, or the like. Particularly, the transparent base 110 may be formed from a glass material, the y value in the color space of which exhibits a change of 0.03 or less when light travels to 1 m in the transparent base 110 in order not to cause a color deviation.

The light-scattering layer 120 is provided on the first surface 111 of the transparent base 110. According to an embodiment, the light-scattering layer 120 may include a matrix 121 and a number of light-scattering particles 122.

The matrix 121 is provided as a layer on the first surface 111 of the transparent base 110. Here, the surface roughness Ra of the matrix 121 may be 1 μm or less. This is because the flatness of the surface of the light-scattering layer 120 should be maintained so that the dot pattern 130 provided on the light-scattering layer 120 can maintain a suitable level of surface tension. In addition, the thickness of the matrix 121 is not specifically limited, as long as light can be scattered at that thickness. For example, the thickness of the matrix 121 may range from 100 nm to 10 μm.

According to an embodiment, the matrix 121 may contain one selected from among, but not limited to, polydimethylsiloxane (PDMS), silsesquioxane (SSQ), and siloxane.

The number of light-scattering particles 122 are dispersed in the matrix 121. According to an embodiment, the light-scattering particles 122 may contain at least one selected from the candidate group consisting of, but not limited to, SiO₂, TiO₂, BaTiO₃, ZnO, ZrO₂, and SnO₂.

The light-scattering layer 120 according to the exemplary embodiment may be provided by dispersing the light-scattering particles 122 in a dispersing solution formed from a high-stability material, such as PDMS, SSQ, or siloxane, coating the first surface 111 of the transparent base 110 with the resultant mixture using spray coating or inkjet coating, and then drying or curing the mixture.

In addition, as illustrated in FIG. 2, the matrix 121 of the light-scattering layer 120 according to the exemplary embodiment may have variations in thickness. The transparent light guide plate 100 according to the exemplary embodiment is used in the edge-lit lighting device 10 (in FIG. 9). Accordingly, a central portion of the light-scattering layer 120 farthest from the LEDs 20 (in FIG. 9) disposed to face the third surface 113, i.e. a side surface of the transparent base 110 may be darker, when the LED is in a turned-on state. To prevent the formation of the dark portion, the central portion of the light-scattering layer 120 may be thicker than the peripheral portion of the light-scattering layer 120. When the central portion of the light-scattering layer 120 is thicker than the other portions, the light-scattering effect of the central portion is relatively increased, so that uniform light-scattering effect can be obtained over the entire area of the light-scattering layer 120. As a result, the edge-lit lighting device 10 (in FIG. 9) can obtain uniform light emission. Here, even in the case in which the central portion is provided to be thicker than the peripheral portions, there is no problem in forming the dot pattern 130 on light-scattering layer 120 having variations in thickness, since the surface roughness Ra of the light-scattering layer 120 is 1 μm or less.

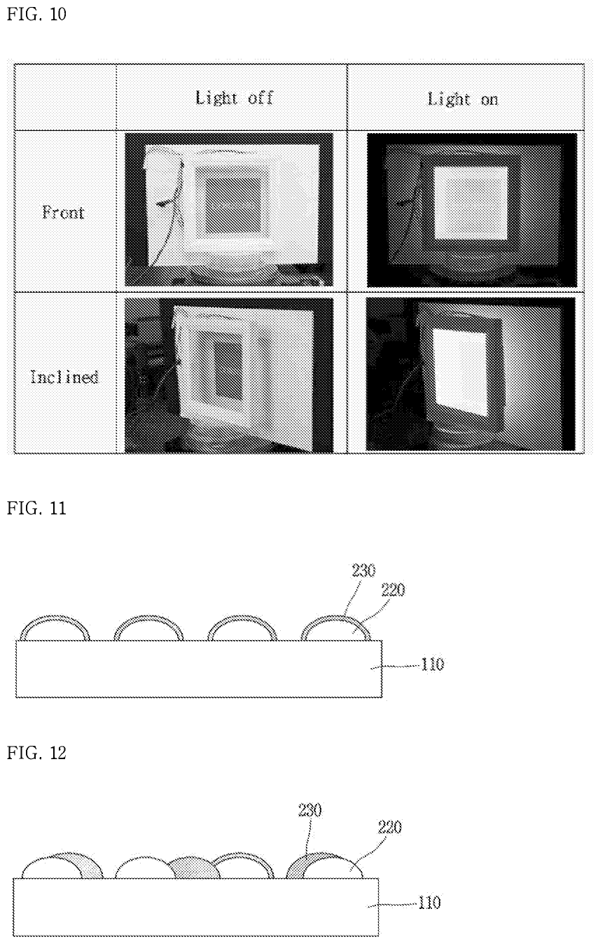

In addition, as illustrated in FIG. 3, according to another embodiment for obtaining uniform light emission of the edge-lit lighting device 10 (in FIG. 10), the matrix 121 may have a uniform thickness, and the number of light-scattering particles 122 present within the matrix 121 may be relatively-densely distributed in the central portion of the matrix 121. This structure can also obtain the same effect as that of the structure in which the central portion of the matrix 121 is thicker than the other portions of the matrix. That is, uniform light emission of the edge-lit lighting device 10 (in FIG. 9) can be obtained.

The dot pattern 130 is provided on the light-scattering layer 120. Here, the dot pattern 130 may be provided on the light-scattering layer 120 at a thickness ranging from 10 nm to 10 μm. According to an embodiment, the dot pattern 130 includes a number of first dots 131. In addition, the dot pattern 130 includes a number of second dots 132. In addition, the dot pattern 130 includes the number of first dots 131 and the number of second dots 132.

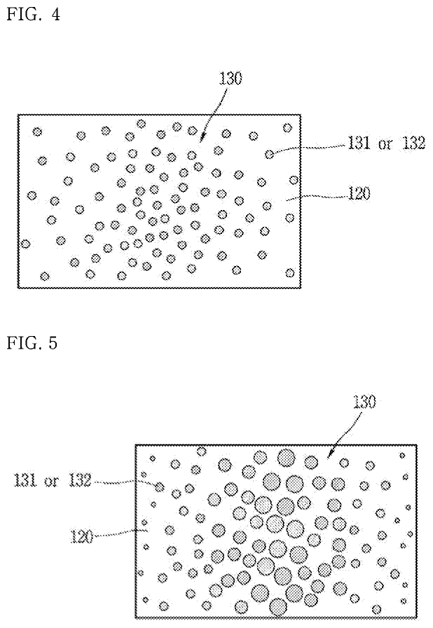

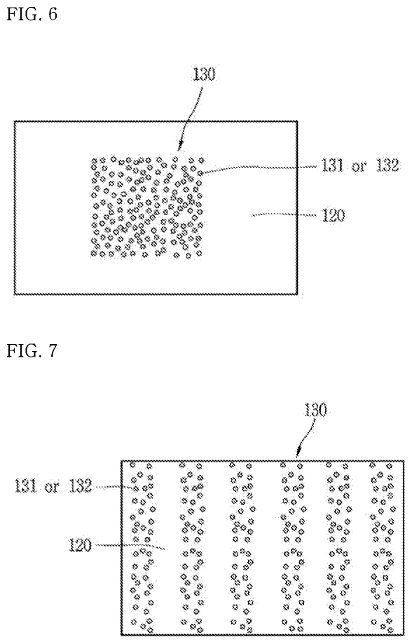

The number of first dots 131 are formed from a light-absorbing material. For example, the number of first dots 131 may be formed from a material having a reflectance of 10% or less. For example, the number of second dots 132 may be formed from a material having a reflectance of 50% or more. As illustrated in FIGS. 4 to 7, the number of first dots 131 and the number of second dots 132 may have a variety shapes, sizes, arrays, and patterns to provide the dot pattern 130. Here, each of the dots of the number of first dots 131 and the number of second dots 132 may have a circular cross-sectional shape or a non-circular cross-sectional shape including a polygonal cross-sectional shape and an elliptical cross-sectional shape. The diameter (or distance between two points most distant from each other) of the number of first dots 131 and the number of second dots 132, e.g. the distance between two diagonal vertices in the case of oblong dots or the distance between two end points of a longer axis in the case of elliptical dots, may range from 20 nm to 40 μm. According to the embodiment, it is possible to easily adjust the amounts or the ratio between intensities of light exiting through both surfaces of the transparent base 110 by controlling the size, number, density, or the like of the number of first dots 131 and the number of second dots 132. The number of first dots 131 and the number of second dots may be formed on the light-scattering layer 120 using spray coating or inkjet coating. When the spray coating or inkjet coating is used, the ratio between intensities of light exiting through both surfaces of the transparent base 110 may be very easily or accurately adjusted. Here, the sequence in which the first dots 131 and the second dots 132 are formed by coating is not limited. A coating solution that is to form the number of first dots 131 and the number of second dots 132 may have viscosity ranging from 0.1 cP to 20 cP. More particularly, the viscosity of the coating solution may be adjusted to range from 5 cP to 15 cP.

In the transparent light guide plate, the number of first dots and the number of second dots may be spaced apart from or overlap the adjacent dots. For example, in a case in which a dot pattern only includes first dots, the first dots may be spaced apart from or overlap the adjacent dots. (That is, i) all of the first dots may be spaced apart from the adjacent dots, ii) all of the first dots may overlap the adjacent dots, or iii) some of the first dots may be spaced apart from the adjacent dots, while the other first dots may overlap the adjacent dots. The same will be applied to the following examples.) For example, in a case in which a dot pattern only includes second dots, the second dots may be spaced apart from or overlap the adjacent dots. For example, in a case in which a dot pattern includes first dots and second dots, the first dots and the second dots may be spaced apart from or overlap the adjacent dots.

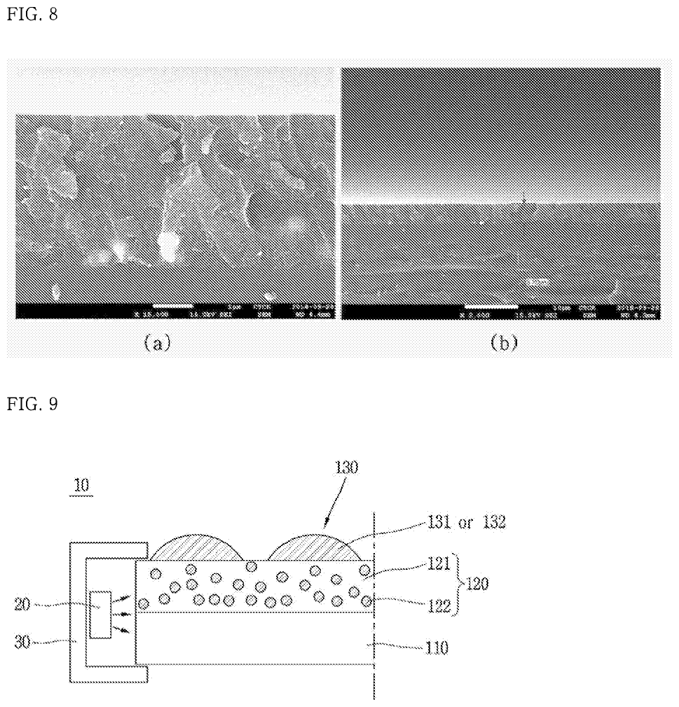

As illustrated in electron microscope images in FIGS. 8A and 8B, in the transparent light guide plate 100 according to an exemplary embodiment, a total thickness of the light-scattering layer 120 and the dot pattern 130 ranges from 110 nm to 20 μm. Due to the very low thickness, the light-scattering layer 120 and the dot pattern 130 may be invisible.

In a light guide plate of the related art fabricated by periodically attaching light-scattering pattern elements having a relatively-large size of several millimeters to a transparent plate, a diffuser is required to be attached to the transparent plate. In contrast, according to the present disclosure, the diffuser of the related art can be removed, since the dot pattern 130 cannot be visually recognized.

As illustrated in FIG. 9, the transparent light guide plate 100 including the transparent base 110, the light-scattering layer 120, and the dot pattern 130 according to the exemplary embodiment, as described above, may be used in the edge-lit lighting device 10.

The lighting device 10 according to the exemplary embodiment includes the above-described transparent light guide plate 100, the LEDs 20, and a frame 30.

The LEDs 20 may be disposed to face at least one surface of the third surfaces 113 defining side surfaces of the transparent light guide plate 100. That is, the LEDs 20 may be disposed to face the left side surface, the right side surface, or both the left and right side surfaces of the transparent light guide plate 100 in the drawing. Here, at least one of the LEDs 20 may be disposed adjacent to each of the side surfaces.

The frame 30 provides a mounting space for the transparent light guide plate 100 and the LEDs 20. Here, according to an embodiment, the frame 30 is disposed to expose both the first surface 111 and the second surface 112 of the transparent light guide plate 100 in order to enable dual-surface lighting. In this regard, the frame 30 may be shaped to enclose the peripheral portions of the transparent light guide plate 100.

Referring to images in FIG. 10, in the lighting device 10, when the LEDs 20 are in a turned-on state, light emitted by the LEDs 20 exits through both the first surface 111 and the second surface 112 of the transparent light guide plate 100, so that the lighting device 10 realizes dual-surface lighting. Here, the ratio of intensities of light exiting through the two surfaces may be substantially the same.

In addition, in the lighting device 10, when the LEDs 20 are in a turned-off state, the transparent light guide plate 100 remains transparent. As a result, for example, a viewer on the side of the first surface 111 may recognize an image behind the lighting device 10 through the transparent light guide plate 100.

In order to realize dual-surface lighting when the LEDs 20 are in a turned-on state and realize the transparent state when the LEDs 20 are in a turned-off state, the hazing of the transparent light guide plate 100 may be 30% or less, and the transparency of the transparent light guide plate 100 may be 80% or higher. The haze of the transparent light guide plate 100 in FIG. 10 was measured to be 10%, and the transparency of the transparent light guide plate 100 was measured to be 89%.

Hereinafter, the transparent light guide plate according a relative example will be described with reference to FIGS. 11 to 14.

FIG. 11 illustrates a light guide plate on which a light-scattering pattern 220 and a reflective pattern (or an absorbing pattern) 230, comparable to the dot pattern 130 (in FIG. 1) according to the exemplary embodiment, are accurately aligned, and FIG. 12 illustrates a light guide plate on which a light-scattering pattern 220 and a reflective pattern 230 are misaligned.

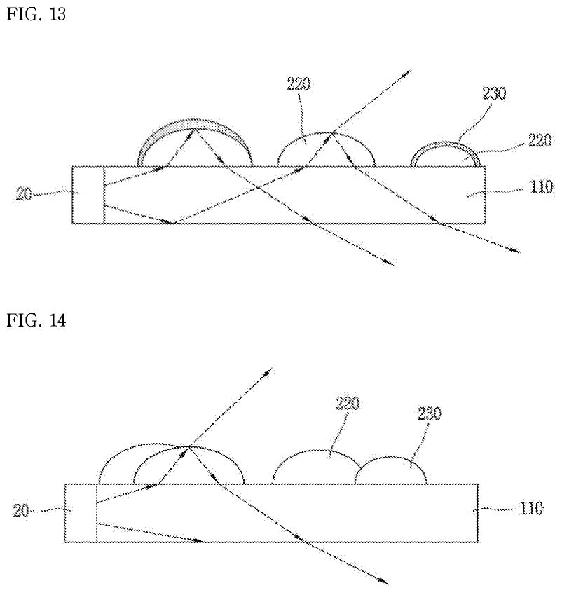

As illustrated in FIG. 13, in a case in which a light-scattering pattern 220 and a reflective pattern (or an absorbing pattern) 230 are accurately aligned, light emitted from an LEDs 20 disposed along the side surface of the transparent base 110 can exit through the transparent base 110, as intended.

However, the process of providing the patterns with an invisible size, e.g. ranging from about 10 μm to about 40 μm overlap, is especially difficult, and expensive equipment is required for such a process.

Even in the case of inkjet coating in which dispensing locations can be accurately controlled, it is impossible, in terms of probability, to eject all droplets necessary for coating to the same locations two times in a row to make the patterns overlap, even in the case that the transparent base 110 is maintained in a fixed position. In addition, in a case in which the size of droplets is set to be tens of micrometers (μm) or less to make the pattern visually unrecognizable for an aesthetic effect, it is more impossible in terms of probability.

In a case in which the light-scattering pattern 220 and the reflective pattern (or the absorbing pattern) 230 are misaligned (FIG. 14), the light-scattering pattern 220 can cause light to leak while the light is being guided, differently from an ordinary light guide situation (FIG. 13). Accordingly, it is impossible to adjust intensities of light exiting through both surfaces of the transparent base 110 at an intended ratio.

FIG. 14 illustrates a situation in which, when the light-scattering pattern 220 and the reflective pattern (or the absorbing pattern) 230 are misaligned or erroneously aligned, light emitted by an LED 20 disposed on a side surface of the transparent base 110 is blocked by the reflective pattern (or the absorbing pattern) 230, thereby failing to exit, although the light is expected to exit along an unintended path.

The foregoing descriptions of specific exemplary embodiments of the present disclosure have been presented with respect to the drawings and are not intended to be exhaustive or to limit the present disclosure to the precise forms disclosed herein, and many modifications and variations would obviously be possible for a person having ordinary skill in the art in light of the above teachings.

It is intended, therefore, that the scope of the present disclosure not be limited to the foregoing embodiments, but be defined by the Claims appended hereto and their equivalents.

1. A transparent light guide plate comprising:
a transparent base having a first surface, a second surface opposing the first surface, and third surfaces connecting the first surface and the second surface to each other;
a light-scattering layer disposed on the first surface, and comprising a matrix layered on the first surface and a number of light-scattering particles dispersed in the matrix; and
a dot pattern disposed on the light-scattering layer, and comprising at least one of a number of first dots formed from a light-absorbing material and a number of second dots formed from a light-reflective material.

2. The transparent light guide plate of claim 1, wherein the matrix has a surface roughness Ra of 1 μm or less.

3. The transparent light guide plate of claim 1, wherein a central portion of the light-scattering layer is thicker than a peripheral portion of the light-scattering layer.

4. The transparent light guide plate of claim 1, wherein the matrix comprises one of polydimethylsiloxane (PDMS), silsesquioxane (SSQ), and siloxane.

5. The transparent light guide plate of claim 1, wherein the number of light-scattering particles are distributed more densely in a central portion of the light-scattering layer than in a peripheral portion of the light-scattering layer.

6. The transparent light guide plate of claim 1, wherein the light-scattering particles comprise at least one selected from the candidate group consisting of SiO₂, TiO₂, BaTiO₃, ZnO, ZrO₂, and SnO₂.

7. The transparent light guide plate of claim 1, wherein the first dots are formed from a material having a reflectance of 10% or less.

8. The transparent light guide plate of claim 1, wherein the second dots are formed from a material having a reflectance of 50% or more.

9. The transparent light guide plate of claim 1, wherein each dot among the number of first dots and the number of second dots is spaced part from or overlaps an adjacent dot among the number of first dots and the number of second dots.

10. The transparent light guide plate of claim 1, wherein a thickness of the dot pattern ranges from 10 nm to 10 μm.

11. The transparent light guide plate of claim 1, wherein each dot among the number of first dots and the number of second dots has a circular cross-sectional shape or a non-circular cross-sectional shape including a polygonal cross-sectional shape and an elliptical cross-sectional shape.

12. The transparent light guide plate of claim 1, wherein a diameter of each dot among the number of first dots and the number of second dots ranges from 20 nm to 40 μm.

13. The transparent light guide plate of claim 1, wherein a total thickness of the light-scattering layer and the dot pattern ranges from 110 nm to 20 μm.

14. A lighting device comprising:
the transparent light guide plate as claimed in claim 1;
at least one light-emitting diode facing at least one surface of the third surfaces defining side surfaces of the transparent light guide plate;
a frame providing an accommodation space for the transparent light guide plate and the light-emitting diode such that the first surface and a second surface are exposed.

15. The lighting device of claim 14, wherein the lighting device emits light through both the first surface and the second surface of the transparent light guide plate when the light-emitting diode is on.

16. The lighting device of claim 14, wherein the transparent light guide plate remains transparent when the light-emitting diode is off.

17. The lighting device of claim 14, wherein the haze of the transparent light guide plate is 30% or less.

18. The lighting device of claim 14, wherein the transmittance of the transparent light guide plate is 80% or higher.
